(19) United States
(12) Patent Application Publication
(10) Pub. No.: US 2011/0172330 A1
(43) Pub. Date: Jul. 14, 2011

(54) POLYPROPYLENE OXIDE-CONTAINING POLYETHERS AND MIXTURES THEREOF WITH POLY(METH)ACRYLATES AS POWDER COATING LEVELING AGENTS

(75) Inventors: Bernd Gobelt, Wesel (DE); Heiko Juckel, Wesel (DE); Thomas Launag, Voerde (DE)

(73) Assignee: BYK-Chemie GmbH, Wesel (DE)

(21) Appl. No.: 12/675,162

(22) PCT Filed: Aug. 2, 2008
(86) PCT No.: PCT/EP2008/006383

§ 371 Date: Mar. 31, 2011

(30) Foreign Application Priority Data
Sep. 11, 2007 (DE) 10 2007 043 048.7

(51) Int. Cl. C09D 167/00; C09D 133/08; C09D 171/02; C09D 163/00; C09D 177/06; C09D 129/04

(52) U.S. Cl. 523/400; 524/502; 524/612; 524/539; 524/514; 524/503; 524/523; 524/538

(57) ABSTRACT

The invention relates to powder coating leveling agents comprising (a) at least one polypropylene oxide-containing polyether having a weight-average molecular weight of more than 1000 g/mol and a polypropylene oxide fraction of more than 75% by weight, and optionally (b) at least one poly(meth)acrylate. The invention further relates to the preparation of such leveling agents and to their use in powder coating materials, and also to powder coating materials comprising the leveling agents.

The invention relates to powder coating leveling agents for powder coating compositions, comprising polypropylene oxide-containing polyethers and mixtures thereof with poly(meth)acrylates, and also to the preparation of such mixtures and to their use as leveling agents (flow-control agents) in powder coating compositions, particularly for surface coatings. The invention further relates to powder coating materials which comprise the leveling agents of the invention.

Coating surfaces are normally not entirely smooth but instead have a more or less structured surface, referred to as waviness or else orange peel structure. These surfaces may be finely structured, with a short wave, or coarsely structured, with a long wave. In the majority of cases this waviness is unwanted. There exists in particular a dependence between the nature of the surface structure and the composition of the coating materials. For instance, it is significant whether the coating material, for example, comprises solvents or else is solvent-free, as is the case for powder coating materials. In the case of the solvent-free powder coating materials, for example, it is absolutely necessary to use leveling agents in their compositions, since without these leveling agents the surfaces obtained are not sufficiently smooth.

The monograph “Performance Enhancement in Coatings” by E. W. Orr (1998, publisher: Hanser, ISBN 3-446-19405-3) describes poly(meth)acrylic esters and polysiloxanes as flow-promoting agents for coatings.

The polysiloxanes employed are usually polydimethyl-siloxanes, polymethylalkylsiloxanes or else polyether-modified or polyester-modified polydimethyl- or poly-methylalkylsiloxanes.

Where poly(meth)acrylates are used it is preferred to use polymers or copolymers of acrylic acid alkyl esters having a chain length of the alkyl radical of 2 to 12 carbon atoms. Examples of such (meth)acrylic acid alkyl esters are ethyl acrylate, n-butyl acrylate, 2-ethylhexyl acrylate or else lauryl acrylate. The products used typically possess weight-average molecular weights of up to 100 000 g/mol.

The poly(meth)acrylate (co)polymers used as flow-promoting agents may be employed as they are or as solutions in organic solvents, but also on carrier materials such as silica, for example. This is customary particularly in the context of use in powder coating materials. The amounts of such products that are employed are typically 0.1% to 2% by weight, based on the coating formulations.

DE 196 44 728 describes, as a further class of compound, polyvinyl ethers as leveling agents for powder coating materials.

The effect of these flow-promoting agents is based on an interface activity at the “liquid/gaseous” interface, at which these products are oriented on the basis of a certain incompatibility with the actual binder of the coating system. This incompatibility may be increased by raising the molecular weight of these polymers. A disadvantage then, however, is that the incompatibility may cause a certain hazing of the coating, and the viscosity of the leveling agent becomes so high that ease of handling for the user is lost or is very difficult. In addition, polysiloxanes have a tendency toward severe incompatibilities with the coating material, as manifested, for example, by cratering in the coating film. This limits the use of polysiloxanes, and especially the amount employed. Nevertheless, they are frequently used in combination with poly(meth)acrylic esters, since in addition to their flow-promoting properties they lower the surface tension of the coating material and hence support the wetting of the substrate by the coating material.

U.S. Pat. No. 3,385,816 describes better leveling of solventborne polyurethane coating materials via a viscosity-reducing effect by adding certain polyether-containing compounds.

Particularly for powder coating materials and for coating materials that are employed in coil coating, however, there is an urgent need for good but inexpensive leveling agents. In these applications, the leveling agent must not only have the flow-promoting property but must also, at the same time, improve the substrate wetting of the coating material, allowing absolutely smooth coating films to be produced.

It has been possible to achieve these objects by means of powder coating leveling agents which comprise (a) at least one polypropylene oxide-containing polyether having a weight-average molecular weight of more then 1000 g/mol, more preferably more than 1500 g/mol, and very preferably more than 2000 g/mol, and a polypropylene oxide fraction of more than 75% by weight, and optionally (b) poly(meth)acrylates. The powder coating leveling agents preferably comprise poly(meth)acrylates (b). The weight-average molecular weight can be determined by means of gel permeation chromatography using a polystyrene standard.

These powder coating leveling agents are referred to below as powder coating leveling agents of the invention or leveling agents of the invention.

The poly(meth)acrylate or (meth)acrylate notation stands herein—as is familiar to a person of ordinary skill in the art for polyacrylate and polymethacrylate, or acrylate and methacrylate, respectively.

In comparison to pure poly(meth)acrylates as leveling agents, the leveling agents of the invention are notable in powder coating materials for slip reduction.

The term “slip reduction” denotes a reduction in the sliding resistance on the cured coating material surface.

When pure poly(meth)acrylates are used, transparent powder coating materials display a tendency toward clouding. Clouding, however, does not occur when the leveling agents of the invention are used, the latter having a broader compatibility than pure poly(meth)acrylates.

The powder coating leveling agents of the invention comprise
(a) at least one polypropylene oxide-containing polyether having a weight-average molecular weight of more than 1000 g/mol, more preferably more than 1500 g/mol, and very preferably more than 2000 g/mol, and a polypropylene oxide fraction of more than 75% by weight, preferably more than 80% by weight, more preferably more than 90% by weight, and very preferably of 100% by weight, and optionally
(b) at least one poly(meth)acrylate.

The leveling agent of the invention may be obtained by an operation of mixing of the two components (a) and (b), which may be assisted by heating of the polymer solutions.

A further, preferred process for preparing the leveling agent of the invention is the preparation of component (b) using component (a) as solvent or carrier medium.

The two components (a) and (b) may be present in different weight fractions in the powder coating leveling agent of the invention. In the leveling agent of the invention, component (a) is present, preferably, at 10% to 100% by weight, more preferably 10% to 75% by weight, and very preferably 10% to 50% by weight, based on the sum of the weight fractions of components (a) and (b). This means that component (b) is present preferably at up to 90% by weight, more preferably at 25% to 90% by weight, and very preferably at 50% to 90% by weight, based on the sum of the weight fractions of components (a) and (b), in the powder coating leveling agent of the invention.

The polyalkylene oxides used as component (a) (and also referred to herein as polyethers) are notable for the fact that they possess a propylene oxide fraction of more than 75% by weight, preferably more than 80% by weight, more preferably more than 90% by weight, and very preferably of 100% by weight, and possess a weight-average molecular weight of more than 1000 g/mol. With very particular preference they are composed only of C, H, and O atoms.

The polyalkylene oxides may be linear polyalkylene oxides, produced starting from a monoalcohol or from a dialcohol. Polyalkylene oxides of this kind, accordingly, have one or two terminal hydroxyl functions. These hydroxyl functions, produced in the course of the preparation of the polyalkylene oxide, may also, however, be endgroup-capped. Examples of this are endgroup capping by alkylation with methyl iodide, or the formation of an acetic ester with acetic anhydride.

Alternatively the polyalkylene oxides used in the leveling agent of the invention may be branched polyalkylene oxides, having three or more arms.

Preferred polyalkylene oxides are those which comprise at least one hydroxyl function. Examples thereof are polyoxypropylene monobutyl ether, polyoxypropylene monoisotridecyl ether, polyoxyethylene-oxypropylene monobutyl ether, polyethylene-polypropylene glycol pentaerythritol ether, polyoxypropylene-polyoxyethylene copolymer, and polyoxypropylene ethers.

Component (b) is a poly(meth)acrylate.

The poly(meth)acrylates may have a random distribution of the monomers along the polymer chain, but may also be constructed as block copolymers or else as gradient copolymers. Examples of block copolymers suitable as leveling agents are found in WO 05/059048 and in U.S. Pat. No. 6,197,883.

The poly(meth)acrylates have a weight-average molecular weight of preferably 1000 to 100 000 g/mol, more preferably 2000 to 50 000 g/mol, and very preferably in the range from 2000 to 20 000 g/mol.

The poly(meth)acrylates preferably possess a glass transition temperature of below 30° C., more preferably below 25° C., thereby distinguishing them significantly from poly(meth)acrylate binders which are used in powder coating materials. The glass transition temperature of the poly(meth)acrylates can be determined in accordance with DIN ISO 11357-2 by means of differential scanning calorimetry (DSC).

The poly(meth)acrylates are preferably constructed from the following free-radically polymerized monomeric units: alkyl (meth)acrylates of straight-chain, branched or cycloaliphatic alcohols having 1 to 22 C atoms, such as methyl (meth)acrylate, ethyl (meth)acrylate, n-butyl (meth)acrylate, isobutyl (meth)acrylate, tert-butyl (meth)acrylate, lauryl (meth)acrylate, 2-ethylhexyl (meth)acrylate, stearyl (meth)acrylate, behenyl (meth)acrylate, cyclohexyl (meth)acrylate, and isobornyl (meth)acrylate; aryl (meth)acrylates, such as benzyl methacrylate or phenyl acrylate, it being possible for each of the aryl radicals to be unsubstituted or to be substituted up to four times.

As monomeric units it is also possible to use ether alcohol-containing monomeric units. Examples thereof are tetrahydrofurfuryl methacrylate, furfuryl methacrylate, 2-butoxyethyl methacrylate, and 2-ethoxy-ethoxyethyl acrylate.

Also possible is the incorporation of polyesters in the form of caprolactone-modified and/or valerolactone-modified monomeric units into the polymeric base molecule. Preference is given to using caprolactone-modified and/or valerolactone-modified hydroxyalkyl (meth)acrylates having a weight-average molecular weight of 220 to 1200 g/mol, the hydroxy (meth)acrylates being derived preferably from straight-chain, branched or cycloaliphatic diols having 2 to 8 carbon atoms.

Further free-radially polymerized monomeric units may be selected, for example, from the group consisting of methacrylates of halogenated alcohols, such as perfluoroalkyl (meth)acrylates having 6 to 20 carbon atoms, styrene, and substituted styrenes having an alkyl substituent on the ring, such as vinyltoluene and p-methylstyrene.

Further possible components (b) of the leveling agents of the invention may be comb copolymers, as are described in EP 1 193 299.

The two components (a) and (b) may be mixed in a mixing operation, which may be supported by heating of the polymer solutions, to form the leveling agents of the invention.

As already mentioned above, a preferred process for obtaining the leveling agent of the invention is the preparation of component (b) using component (a) as a solvent or carrier medium.

In this case, the preparation of the poly(meth)acrylate, i.e., of component (b), takes place in component (a) in the way which is known to the skilled worker.

Component (b) may be prepared via free-radically initiated polymerization, for example, with azo initiators or peroxide initiators. Suitable initiators include peroxides such as tert-butyl peroxobenzoate or dibenzoyl peroxide, for example. It is also possible, however, for azo compounds such as azoisobutyronitrile

(AIBN), for example, to be used. Preference is given to using peroxides.

The polymerization is carried out preferably at temperatures of about 40° C. to 180° C., more preferably at 100° C. to 150° C., very preferably at 110° C. to 130° C. In order to set the desired weight-average molecular weight, it is possible for chain regulators (chain transfer agents) such as, for example, thiols, secondary alcohols or alkyl halides such as carbon tetrachloride to be added during the polymerization. Further preparation processes for poly(meth)acrylates may be controlled polymerization processes, such as, for example:
the Reversible Addition Fragmentation Chain Transfer Process (RAFT), which when certain polymerization regulators are used is also called

MADIX and Addition Fragmentation Chain Transfer, referred to here only as RAFT, as is described, for example, in Polym. Int. 2000, 49, 993, Aust. J. Chem 2005, 58, 379, J. Polym. Sci. Part A: Polym. Chem. 2005, 43, 5347, US 6 291 620, WO 98/01478, WO 98/58974 and WO 99/31144,
controlled polymerization with nitroxyl compounds as polymerization regulators (NMP), as disclosed, for example, in Chem. Rev. 2001, 101, 3661.
Atom Transfer Radical Polymerization (ATRP), as described in WO 96/30421, for example,
Group Transfer Polymerization (GTP) as described, for example, by O. W. Webster in “Group Transfer Polymerization”, in “Encyclopedia of Polymer Science and Engineering”, volume 7, H. F. Mark, N. M. Bikales, C. G. Overberger and G. Menges, Eds., Wiley Interscience, New York 1987, page 580 ff.,
controlled free-radical polymerization with organocobalt complexes, as is described, for example, in J. Am. Chem. Soc. 1994, 116, 7973.

The leveling agents of the invention are used in the coating formulations in relatively small amounts of 0.01% to 5% by weight, preferably 0.05% to 2% by weight, very preferably 0.01% to 1% by weight.

The leveling agents of the invention may be applied as solutions, emulsions, to powders, such as silicas, for example, or employed as 100% materials, depending on the nature and mode of application of the coating material.

In solventborne coating materials it is preferred to use leveling agents which are diluted in similar solvents to those of the coating materials themselves. In radiation-curing systems, leveling agents are diluted preferably in corresponding monomers.

In powder coating materials, preference is given to a 100% version of the leveling agent, or to a form of these leveling agents that is applied to carrier material in powder form. These leveling agents, in accordance with German patent application DE-A-195 22 475, may also be incorporated into wax melts and in that way converted into free-flowing solid forms, particularly when the leveling agents of the invention are viscous, tacky polymers. In aqueous powder slurries, a sub-type of the powder coating materials, the leveling agents may be added in the form of an aqueous emulsion. These emulsions are prepared in accordance with the prior art, with the aid of emulsifiers.

The invention also relates to the use of the powder coating leveling agents of the invention in or for preparing powder coating materials.

The invention additionally relates to powder coating materials which comprise the leveling agent of the invention in a concentration of 0.01% to 5% by weight, preferably 0.05% to 2% by weight, more preferably 0.1% to 1% by weight, based on the total weight of the powder coating material.

The powder coating materials may be thermosetting powder coating types, such as, for example, epoxy resins, hybrid systems with COOH-functional polyester resins, triglycidyl isocyanurate-based resins, tetrahydroxyalkylbisamide-based resins, polyurethane resins, and poly(meth)acrylate resins, the latter having a glass transition temperature of preferably more than 30° C., more preferably more than 35° C. Alternatively the powder coating materials may be thermoplastic coating powders, based for example on polymers such as polyamide 11 and 12, polyethylene, copolymers with vinyl alcohol (EVOH systems), polyvinyl chloride, and fluoropolymers.

Further examples of powder coating materials, powder coating base materials, and powder coating formulations are listed in the following monograph: Pieter Gillis de Lange “Powder Coatings, Chemistry and Technology”, 2004 (publisher: Vincentz Network, ISBN 3-87870-784-3) and in DE 196 44 728 and the references cited therein.

### PREPARATION EXAMPLES

The invention is additionally elucidated by the examples below:
Polyether 1: monohydroxy-functional polypropylene oxide polyether prepared starting from butanol, M_{w} about 1250 g/mol
Polyether 2: monohydroxy-functional polypropylene oxide polyether prepared starting from butanol, M_{w} about 4600 g/mol
Polyether 3: monohydroxy-functional polypropylene oxide polyether prepared starting from butanol, M_{w} about 7300 g/mol
Polyether 4: dihydroxy-functional polypropylene oxide polyether, M_{w} about 850 g/mol
Polyether 5: dihydroxy-functional polypropylene oxide polyether, M_{w} about 7500 g/mol
Polyether 6: monohydroxy-functional polypropylene oxide-polyethylene oxide copolyether prepared starting from butanol, ethylene oxide-propylene oxide ratio 30:70, M_{w} about 4000 g/mol
Polyether 7: dihydroxy-functional polypropylene oxide-polyethylene oxide block copolymer, ethylene oxide-propylene oxide ratio 80:20, M_{w} about 9900 g/mol

The weight-average molecular weights M_{w} were determined by means of gel permeation chromatography (GPC). For this method, polystyrene was used as a standard.

### 1) Preparation of the Polyacrylate Copolymer PA1 in Xylene

A glass flask provided with stirrer, thermometer, reflux condenser, and nitrogen inlet tube was charged under an N₂ atmosphere with 42.5 g of xylene, which was heated to boiling. Over 4 h, a mixture of 51.6 g of 2-ethylhexyl acrylate, 118.5 g of n-butyl acrylate and 0.09 g of di-tert-butyl peroxide was metered in, the reaction temperature being raised during the polymerization, so that polymerization was carried out always under boiling conditions. Subsequently a further 0.01 g of di-tert-butyl peroxide was added. After a post-reaction time of 1 h, the solvent was distilled off.

### 2) Preparation of the Polyacrylate Copolymer PA2 in Polyether 3

A glass flask provided with stirrer, thermometer, reflux condenser, and nitrogen inlet tube was charged under an N₂ atmosphere with 57 g of polyglycol B01/240, which was heated to boiling. Over 4 h, a mixture of 51.6 g of 2-ethylhexyl acrylate, 118.5 g of n-butyl acrylate and 0.09 g of di-tert-butyl peroxide was metered in, the reaction temperature being raised during the polymerization, so that polymerization was carried out always under boiling conditions. Subsequently a further 0.01 g of di-tert-butyl peroxide was added. After a post-reaction time of 1 h, the reaction mixture was cooled.

3) PA3: Mixture of PA 1 with Polyether 3

57 g of polyether 3 and 170 g of PA1 are mixed at room temperature.

4) Powder 1: Mixture of PA 1 with Siperanat 22

35 g of Sipernat 22 (precipitated silica, manufacturer: Degussa) are charged to a kitchen mixer (“Assistent” stand mixer from AEG) and over 5 minutes, with stirring, 65 g of PA1 are metered in.

5) Powder 2: Mixture of PA 3 with Siperanat 22

35 g of Sipernat 22 are introduced into a kitchen mixer and, over 5 minutes, with stirring, 65 g of PA3 are metered in.

### General Preparation of the Powder Coating Materials:

The leveling agents according to the examples were incorporated in the form of 10% masterbatches into the powder coating resin. This was taken into account with regard to the initial mass of resin. The masterbatch is produced by melting the corresponding powder coating resin and mixing it with the leveling agent. After cooling, the masterbatch mixture is comminuted.

All of the components were weighed out together and premixed for 2.5 minutes at 2000 rpm in a high-speed Mixaco Lab CM3 mixer. Thereafter the mixtures were extruded at 120° C. in a Prism TSE 16 twin-screw extruder. The resulting resin melt was cooled, fractionated, and ground in a Retsch ZM 100 pinned disk mill. The resulting powder was applied to a 100 μm sieve.

The powder coating mixture produced in this way was then applied electrostatically to phosphated iron panels, and the panels thus coated were cured at 190° C. for 12 minutes.

Evaluation of the resultant surface of the powder coatings:
ok excellent applied powder coating
MC microcraters up to approximately 1 mm in diameter
C visible craters, some going down to the metal
   Testing in a White Polyester Hybrid Powder Coating Material with Uralac P 5170

| | | | |
|---|---|---|---|
| Uralac P5127 | 35.6 | parts by wt. | polyester resin, DSM |
| DER 663 UE | 35.6 | parts by wt. | epoxy resin, Dow |
| Kronos 2160 | 28.5 | parts by wt. | titanium dioxide, |
| | | | Kronos |
| Benzoin | 0.3 | part by wt. | DSM |
| Leveling agent | 0.8 | part by wt. | see results table |

Result:

| | Film | | | | Reduction in slip |
|---|---|---|---|---|---|
| | thickness | | | | resistance relative |
| Additive | μm | ok | MC | C | to blank sample |
| Blank sample* | 70-75 | | | X | |
| PA 1 | 65-70 | X | | | no |
| Polyether 4 | 70-75 | | | X | |
| Polyether 1 | 70-75 | X | | | yes |
| Polyether 2 | 70-75 | X | | | yes |
| Polyether 5 | 65-70 | X | | | yes |
| Polyether 6 | 65-70 | | | X | |
| Polyether 7 | 70-75 | | | X | |
| PA 2 | 75-80 | X | | | yes |
| PA 3 | 65-70 | X | | | yes |

*Composition without leveling agent (all other weight fractions as above)

Testing in a White Polyester Powder Coating Material with Uralac P 2617-3

| | | | |
|---|---|---|---|
| Uralac P2617-3 | 65.4 | parts by wt. | polyester resin, DSM |
| Primid XL-552 | 3.4 | parts by wt. | hydroxyalkylamide |
| | | | crosslinker, EMS-Chemie |
| Kronos 2160 | 30 | parts by wt. | titanium dioxide, Kronos |
| Benzoin | 0.4 | part by wt. | DSM |
| Leveling agent | 0.8 | part by wt. | see results table |

Result:

| | Film thickness | | | |
|---|---|---|---|---|
| Additive | μm | ok | MC | C |
| Blank sample* | 65-70 | | | X |
| PA 1 | 65-70 | X | | |
| Polyether 2 | 65-70 | X | | |
| PA 2 | 70-75 | X | | |
| PA 3 | 60-65 | X | | |

*Composition without leveling agent (all other weight fractions as above)

Testing in a Transparent Polyester Powder Coating with Uralac P 865

| | | | |
|---|---|---|---|
| Uralac P865 | 94.1 | parts by wt. | polyester resin, EMS-Chemie |
| Primid XL-552 | 4.9 | parts by wt. | hydroxyalkylamide |
| | | | crosslinker, EMS-Chemie |
| Benzoin | 0.5 | part by wt. | DSM |
| Leveling agent | 0.5 | part by wt. | see results table |

Result:

| | Film thickness | | | |
|---|---|---|---|---|
| Additive | μm | ok | MC | C |
| Blank sample* | 55-60 | | | X |
| PA 1 | 60-65 | X | | |
| Polyether 2 | 60-65 | X | | |
| PA 2 | 60-65 | X | | |
| PA 3 | 65-70 | X | | |

*Composition without leveling agent (all other weight fractions as above)

Testing in a Transparent Polyester Hybrid Powder coating with Uralac P 3495

| | | | |
|---|---|---|---|
| Uralac P3495 | 91.1 | parts by wt. | Polyester resin, DSM |
| Araldite | 6.9 | parts by wt. | triglycidyl trimellitate |
| PT 910 | | | crosslinker, Vanitco |
| Benzoin | 0.4 | part by wt. | DSM |
| Leveling agent | 0.8 | part by wt. | see results table |

Result:

| | Film thickness | | | |
|---|---|---|---|---|
| Additive | μm | ok | MC | C |
| Blank sample* | 75-80 | | | X |
| PA 1 | 75-80 | X | | |
| Polyether 2 | 75-80 | X | | |
| PA 2 | 75-80 | X | | |
| PA 3 | 75-80 | X | | |

*Composition without leveling agent (all other weight fractions as above)

Testing in a Transparent Epoxy Coating with Epikote 3003

| | | | |
|---|---|---|---|
| Epikote 3003 | 95.0 | parts by wt. | epoxy resin, |
| | | | Resolution |
| Epicure P 108 | 4.0 | parts by wt. | dicyandiamide |
| | | | hardener, Resolution |
| Benzoin | 0.4 | part by wt. | DSM |
| Leveling agent | 0.6 | part by wt. | see results table |

Result:

| | Film thickness | | | |
|---|---|---|---|---|
| Additive | μm | ok | MC | C |
| Blank sample* | 70-75 | | | X |
| PA 1 | 65-70 | X | | |
| Polyether 2 | 65-70 | X | | |
| PA 2 | 70-75 | X | | |
| PA 3 | 65-70 | X | | |

*Composition without leveling agent (all other weight fractions as above)

Testing of the Leveling Agents in Powder form in a White Polyester Hybrid Powder Coating with Uralac P 5170

| | | | |
|---|---|---|---|
| Uralac P5127 | 35.6 | parts by wt. | polyester resin, DSM |
| DER 663 UE | 35.6 | parts by wt. | epoxy resin, Dow |
| Kronos 2160 | 28.5 | parts by wt. | titanium dioxide, |
| | | | Kronos |
| Benzoin | 0.3 | part by wt. | DSM |
| Leveling agent | 1.25 | parts by wt. | see results table |

All of the components were weighed out together and premixed for 2.5 minutes at 2000 rpm in a high-speed Mixaco Lab CM3 mixer. Thereafter the mixtures were extruded at 120° C. in a Prism TSE 16 twin-screw extruder. The resulting resin melt was cooled, fractionated, and ground in a Retsch ZM 100 pinned disk mill. The resulting powder was applied to a 100 μm sieve.

The powder coating mixture produced in this way was then applied electrostatically to phosphated iron panels, and the panels thus coated were cured at 190° C. for 12 minutes.

Result:

| | Film | | | | Reduction in slip |
|---|---|---|---|---|---|
| | thickness | | | | resistance relative |
| Additive | μm | ok | MC | C | to blank sample |
| Blank sample* | 70-75 | | | X | |
| Powder 1 | 60-75 | X | | | no |
| Powder 2 | 75-78 | X | | | yes |

*Composition without leveling agent (all other weight fractions as above)

1. A powder coating leveling agent comprising
(a) at least one polypropylene oxide-containing polyether having a weight-average molecular weight of more then 1000 g/mol and a polypropylene oxide fraction of more than 75% by weight, and optionally
(b) at least one poly(meth)acrylate.

2. The powder coating leveling agent of claim 1, where the polypropylene oxide-containing polyether possesses a polypropylene oxide fraction of more than 80% by weight.

3. The powder coating leveling agent of claim 2, where the polypropylene oxide-containing polyether possesses a polypropylene oxide fraction of more than 90% by weight.

4. The powder coating leveling agent of claim 3, where the polypropylene oxide-containing polyether possesses a polypropylene oxide fraction of 100% by weight.

5. The powder coating leveling agent of claim 1, where the poly(meth)acrylate possesses a weight-average molecular weight of 1000 to 100 000 g/mol.

6. The powder coating leveling agent of claim 5, where the poly(meth)acrylate possesses a weight-average molecular weight of 2000 to 50 000 g/mol.

7. The powder coating leveling agent of claim 6, where the poly(meth)acrylate possesses a weight-average molecular weight of 2000 to 20 000 g/mol.

8. The powder coating leveling agent of claims 1, where the glass transition temperature of the poly(meth)acrylate is less than 30° C.

9. The powder coating leveling agent of claim 1, where the polypropylene oxide-containing polyether or polyethers (a) are present in an amount of 10% to 100% by weight, based on the sum of the weight fractions of polypropylene oxide-containing polyether (a) and poly(meth)acrylate (b).

10. The powder coating leveling agent of claim 9, where the polypropylene oxide-containing polyether or polyethers (a) are present in an amount of 10% to 75% by weight, based on the sum of the weight fractions of polypropylene oxide-containing polyether (a) and poly(meth)acrylate (b).

11. The powder coating leveling agent of claim 10, where the polypropylene oxide-containing polyether or polyethers (a) are present in an amount of 10% to 50% by weight, based on the sum of the weight fractions of polypropylene oxide-containing polyether (a) and poly(meth)acrylate (b).

12. A process for preparing a powder coating leveling agent of claim 1, characterized in that the poly(meth)acrylate or poly(meth)acrylates (b) are prepared by free-radical polymerization in the polypropylene oxide-containing polyether or polyethers (a).

13. The use of the powder coating leveling agents defined as claimed in claim 1 or prepared as claimed in claim 12 in thermosetting or thermoplastic powder coating materials.

14. The use of claim 13, where the thermosetting powder coating material comprises as binder at least one binder selected from the group consisting of epoxy resins, hybrid systems with carboxy-functional polyester resins, triglycidyl isocyanurate-based resins, tetrahydroxyalkylbisamide-based resins, polyurethane resins, and poly(meth)acrylate resins.

15. The use of claim 13, where the thermoplastic powder coating material comprises at least one polymer from the group consisting of polyamide 11, polyamide 12, polyethylene, copolymers of vinyl alcohol, polyvinyl chloride and fluoropolymers.

16. The use of claim 13, where the powder coating leveling agent is used as it is or bound to a solid carrier material in the powder coating material.

17. A powder coating material comprising a powder coating leveling agent as claimed in claim 1 or prepared as claimed in the process of claim 12, in an amount of 0.01% to 5% by weight, based on the total weight of the powder coating material.

18. The powder coating material of claim 17, where the powder coating leveling agent is present in an amount of 0.05% to 2% by weight, based on the total weight of the powder coating material.

19. The powder coating material of claim 18, where the leveling agent is present in an amount of 0.1% to 1% by weight, based on the total weight of the powder coating material.

20. The powder coating material of claim 17, being a thermosetting or thermoplastic powder coating material.

21. The powder coating material of claim 20, where the thermosetting powder coating material comprises as binder at least one binder selected from the group consisting of epoxy resins, hybrid systems with carboxy-functional polyester resins, triglycidyl isocyanurate-based resins, tetrahydroxyalkylbisamide-based resins, polyurethane resins, and poly(meth)acrylate resins.

22. The powder coating material of claim 20, where the thermoplastic powder coating material comprises at least one polymer from the group consisting of polyamide 11, polyamide 12, polyethylene, copolymers of vinyl alcohol, polyvinyl chloride and fluoropolymers.
